(19) United States
(12) Patent Application Publication
(10) Pub. No.: US 2026/0042104 A1
(43) Pub. Date: Feb. 12, 2026

(54) NOZZLE AND EJECTOR INCLUDING THE SAME

(71) Applicants: Hyundai Motor Company, Seoul (KR); Kia Corporation, Seoul (KR)

(72) Inventor: In Tae Park, Hwaseong-si (KR)

(21) Appl. No.: 18/965,288

(22) Filed: Dec. 2, 2024

(30) Foreign Application Priority Data
Aug. 12, 2024 (KR) 10-2024-0107651

(51) Int. Cl. B05B 1/12; B05B 7/00

(52) U.S. Cl. CPC B05B 1/12; B05B 7/0087

(57) ABSTRACT

A nozzle includes an intake portion into which a fluid is introduced and a connecting portion having one side connected to the intake portion and the other side having a spray hole, wherein the spray hole has an area changing, depending on the introduced fluid.

### CROSS-REFERENCE TO RELATED APPLICATION(S)

This application claims benefit of priority to Korean Patent Application No. 10-2024-0107651 filed on Aug. 12, 2024 in the Korean Intellectual Property Office, the disclosure of which is incorporated herein by reference in its entirety.

### TECHNICAL FIELD

The present disclosure relates to a nozzle and an ejector including the nozzle.

### BACKGROUND

An ejector refers to a type of pump that may eject a fluid (e.g., water, steam, air, etc.) under pressure at high speed from an outlet. The ejector may displace fluid and/or material (e.g., send surrounding fluid to another place). An ejector may intake (e.g., suction) and/or transport a second fluid by utilizing a high-speed flow of a first fluid.

An ejector may exhibit optimal performance in a specific flow rate range. More specifically, if a nozzle provided on the ejector is small, the ejector may eject fluid at high speed at a low flow rate (e.g., may not be able to eject fluid at a high flow rate). If the nozzle is large, the ejector may eject fluid at a high flow rate but at a lower speed (e.g., may not be able to eject fluid at a high speed and at a low flow rate).

It may be difficult for existing ejectors to exhibit optimal performance in a high flow rate range. Different ejectors may need to be designed and manufactured to suit different specific flow rates.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a nozzle and/or an ejector comprising a nozzle. A nozzle may comprise: an intake portion forming an opening configured to introduce a fluid to the nozzle; and a nozzle body having a first end connected to the intake portion and a second end, opposite to the first end, forming a spray hole. An area of the spray hole may be configured to change based on a flow rate of the introduced fluid.

Also, or alternatively, a nozzle may comprise a nozzle body having a first end configured to receive a fluid and a second end, opposite to the first end, forming a spray hole. The nozzle body may comprise a first nozzle body wall; and a second nozzle body wall provided inside the first nozzle body wall. The second nozzle body wall may comprise an elastic material configured to cause an area of the spray hole to change based on a flow rate of the received fluid.

Also, or alternatively, an ejector may comprise a chamber, a nozzle a second intake portion forming an opening configured to provide a second fluid to the chamber; and a discharge nozzle, connected to the chamber, configured to discharge the first fluid and the second fluid from the chamber. The nozzle may comprise a first intake portion forming an opening configured to introduce a first fluid to the nozzle; and a nozzle body having a first end connected to the first intake portion and a second end, opposite to the first end, forming a spray hole configured to provide the first fluid to the chamber. An area of the spray hole may be configured to change based on a flow of the first fluid. Also, or alternatively, the nozzle may comprise a nozzle body having a first end configured to receive the first fluid and a second end, opposite to the first end, forming a spray hole. The nozzle body may comprise a first nozzle body wall and a second nozzle body wall provided inside the first nozzle body wall. The second nozzle body wall may comprise an elastic material configured to cause an area of the spray hole to change based on a flow rate of the received fluid.

These and other features and advantages are described in greater detail below.

### BRIEF DESCRIPTION OF DRAWINGS

These and other aspects, features, and advantages of the present disclosure will be more clearly understood from the following detailed description, taken in conjunction with the accompanying drawings, in which:

FIG. 1 is a conceptual diagram of an ejector including a nozzle according to an example of the present disclosure;

FIG. 2A is a side cross-sectional view of an ejector including a nozzle in a low flow rate state according to a first example of the present disclosure;

FIG. 2B is a front view of a second connecting portion in a low flow rate state according to the first example of the present disclosure;

FIG. 3A is a side cross-sectional view of an ejector including a nozzle in a high flow rate state according to the first example of the present disclosure;

FIG. 3B is a front view of a second connecting portion in a high flow rate state according to the first example of the present disclosure;

FIG. 4A is a side cross-sectional view of an ejector including a nozzle in a low flow rate state according to a second example of the present disclosure;

FIG. 4B is a front view of a second connecting portion and an elastic portion in a low flow rate state according to the second example of the present disclosure;

FIG. 5A is a side cross-sectional view of an ejector including a nozzle in a high flow rate state according to the second example of the present disclosure;

FIG. 5B is a front view of a second connecting portion and an elastic portion in a high flow rate state according to the second example of the present disclosure;

FIG. 6 is a graph illustrating a spring deformation when an elastic portion is a diaphragm spring according to an example of the present disclosure;

FIG. 7A is a side cross-sectional view of an ejector including a nozzle in a low flow rate state according to a third example of the present disclosure;

FIG. 7B is a front view of a second connecting portion and an elastic portion in a low flow rate state according to the third example of the present disclosure;

FIG. 8A is a side cross-sectional view of an ejector including a nozzle in a high flow rate state according to the third example of the present disclosure;

FIG. 8B is a front view of a second connecting portion and an elastic portion in a high flow rate state according to the third example of the present disclosure;

FIG. 9 is a graph illustrating a spring deformation when the elastic portion is a plate spring according to an example of the present disclosure;

FIG. 10A is a side cross-sectional view of an ejector including a nozzle in a low flow rate state according to a fourth example of the present disclosure;

FIG. 10B is a cross-sectional view taken along line I-I′ of FIG. 10A;

FIG. 11A is a side cross-sectional view of an ejector including a nozzle in a high flow rate state according to the fourth example of the present disclosure;

FIG. 11B is a cross-sectional view taken along line II-II′ of FIG. 11A;

FIG. 12A is a side cross-sectional view of an ejector including a nozzle in a low flow rate state according to a fifth example of the present disclosure;

FIG. 12B is a cross-sectional view taken along line III-III′ of FIG. 12A;

FIG. 13A is a side cross-sectional view of an ejector including a nozzle in a high flow rate state according to the fifth example of the present disclosure;

FIG. 13B is a cross-sectional view taken along line IV-IV′ of FIG. 13A;

FIGS. 14A and 14B are views illustrating an example of a second connecting portion according to the first example in a high flow rate state and a nozzle connecting portion according to the fifth example.

FIG. 15A is a side cross-sectional view of an ejector including a nozzle in a low flow rate state according to a sixth example of the present disclosure;

FIG. 15B is a front view of a second connecting portion in a low flow rate state according to the sixth example of the present disclosure;

FIG. 16A is a side cross-sectional view of an ejector including a nozzle in a high flow rate state according to the sixth example of the present disclosure; and

FIG. 16B is a front view of a second connecting portion in a high flow rate state according to the sixth example of the present disclosure.

### DETAILED DESCRIPTION

While the present disclosure may be modified in various ways and take on various alternative forms, specific examples thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe examples of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

Hereinafter, examples of the present disclosure will be described with reference to the accompanying drawings.

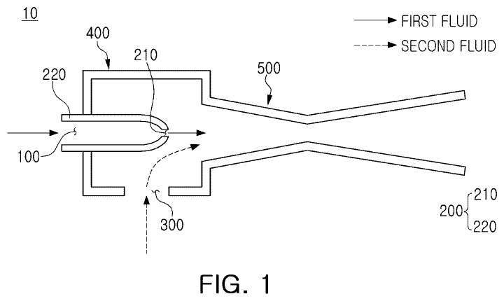

FIG. 1 is a conceptual diagram of an ejector 10 including a nozzle 200 according to an example of the present disclosure.

Referring to FIG. 1, the ejector 10 including the nozzle 200 according to an example of the present disclosure may include a chamber portion 400 (e.g., a chamber) connected to a second intake portion 300 (from which the chamber portion 400 intakes a second fluid) and connected to the nozzle 200 (from which the chamber portion 400 intakes a first fluid). The nozzle 200 may be connected to a first intake portion 100 (from which the nozzle 200 intakes the first fluid) and may discharge the first fluid to the chamber portion 400. A discharge portion 500 (e.g., outlet, second nozzle/diffuser, etc.) connected to the chamber portion 400 may be configured to transfer/discharge the first fluid and the second fluid.

The ejector 10 may be a device in which, based on the first fluid being intaken via the nozzle 200 and flowing through the chamber portion 400 at a high speed, a dynamic pressure inside the chamber 400 decreases, and the second fluid may be intaken (e.g., based on the dynamic pressure decrease) into the chamber 400 (e.g., in which pressure was lowered due to the first fluid). The second fluid may be transferred (e.g., discharged from the discharge portion 500) together with the first fluid.

The discharge portion 500 may have a venturi shape, but is not limited thereto.

The nozzle 200 may further include a connecting portion 220 (e.g., nozzle body between a first intake portion 100 and a spray hole 210) that may be connected to a first intake portion supply line on a side of the first intake portion 100.

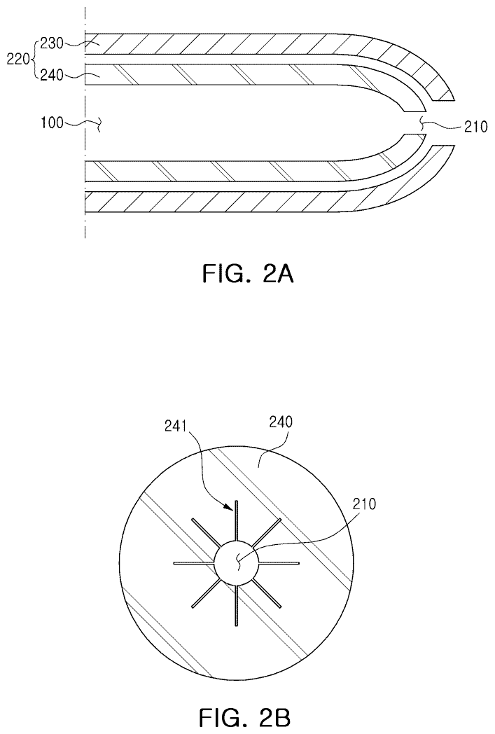

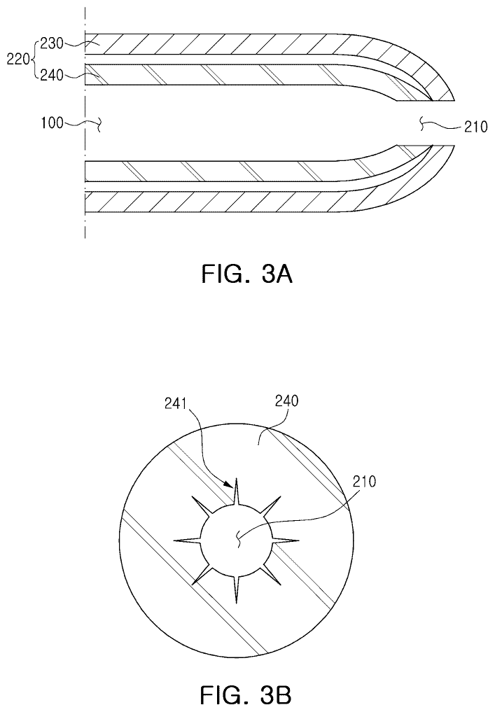

FIG. 2A is a side cross-sectional view of the nozzle 200 in a low flow rate state according to a first example of the present disclosure. FIG. 2B is a front view of a second connecting portion 240 in a low flow rate state according to the first example of the present disclosure, FIG. 3A is a side cross-sectional view of the nozzle 200 in a high flow rate state according to the first example of the present disclosure, and FIG. 3B is a front view of the second connecting portion 240 in a high flow rate state according to the first example of the present disclosure.

Referring to FIGS. 2A to 3B, together with FIG. 1, the ejector 10 including the nozzle 200 according to the first example of the present disclosure may include a connecting portion 220 (alternatively referred to as a nozzle body) comprising two connecting portions (e.g., nozzle body walls): a first connecting portion 230 (e.g., a first nozzle body wall) and a second connecting portion 240 (e.g., a second nozzle body wall).

The ejector 10 may include a first connecting portion 230 provided externally to a second connecting portion 240 (e.g., the second connecting portion may be provided on an inner side of the first connecting portion 230). The first connecting portion 230 and the second connecting portion may be spaced apart from the each other by a predetermined space (e.g., forming a gap in between).

The first connecting portion 230 and the second connecting portion 240 may each be open at a first end (e.g., an intake end) and a second end (e.g., an ejection end). One side (e.g., the first/intake ends) of each of the first connecting portion 230 and the second connecting portion 240 may be connected to the first intake portion 100, and the other side (e.g., the second/ejection ends) of each of the first connecting portion 230 and the second connecting portion 240 may be provided with a spray hole 210.

The connecting portion 220 may intake the first fluid through the first intake portion 100 (e.g., via the first/intake ends) and discharge the first fluid into the chamber portion 400 through the spray hole 210 (e.g., in the second/ejection ends).

Here, an area (e.g., cross-section) of the spray hole 210 may be less than an area (e.g., cross-section) of the first intake portion 100. A speed of the first fluid may increase via/based on/according to a difference in the areas between the first intake portion 100 and the spray hole 210.

The smaller the area of the spray hole 210 (e.g., as the area of the spray hole 210 decreases), the ejector 10 may discharge the first fluid at higher speed and a smaller flow rate. The greater the area of the spray hole 210 (e.g., as the area of the spray hole 210 increases), the ejector 10 may discharge the first fluid at lower speed and a greater flow rate.

The second connecting portion 240 according to an example of the present disclosure may be configured to allow for the area of the spray hole 210 to change, which may provide an advantage of maintaining performance of the ejector 10/nozzle 200 herein over a wide flow rate range (e.g., relative to an ejector/nozzle without an adjustable spray hole area).

According to an example of the present disclosure, the second connecting portion 240 may include at least one cut portion 241 cut in a longitudinal direction (e.g., approximately parallel to a fluid flow direction) of the second connecting portion 240 and along an internal circumferential surface of the spray hole.

Referring to FIG. 2B, if a flow rate of the first fluid is small, the cut portion 241 may be closed. Closing the cut portion 241 may correspond to the second connecting portion 240 having a minimum area when in an open state.

Referring to FIG. 3B, when the flow rate of the first fluid increases, the cut portion 241 may be (e.g., gradually) opened (e.g., by flow pressure of the first fluid). As the size of the spray hole 210 (now including the open area of the cut portion 241) increases (e.g., with opening of the cut portion 241), the flow rate of the first fluid being discharged may also increase.

The second connecting portion 240 may spray the first fluid by opening the cut portion 241 provided along the circumference of the spray hole 210. As such, the first fluid may be sprayed in a shape similar to a star (⋆) (or approximately a shape of the spray hole 210) rather than a circle.

Since the first fluid is discharged in a shape similar to a star, the surface area in which the first fluid and the second fluid are in contact with each other may increase, thereby increasing the performance of the first fluid transferring the second fluid.

Here, the second connecting portion 240 may be formed of an elastic member/material.

For example, the member of the second connecting portion 240 may be formed of a rubber material (ethylene propylene diene monomer (EPDM), fluoroelastomer (FKM), thermoplastic polyurethane (TPU), etc.), an organic elastic material, a metal/plastic elastic material, etc.

The second connecting portion 240 being formed of an elastic member/material, may allow for a degree of opening of the cut portion 241 to be changed according to the pressure and/or a flow rate of the first fluid. The flow rate and/or flow speed of the first fluid may be adjusted based on the change in the degree of opening of the cut portion 241.

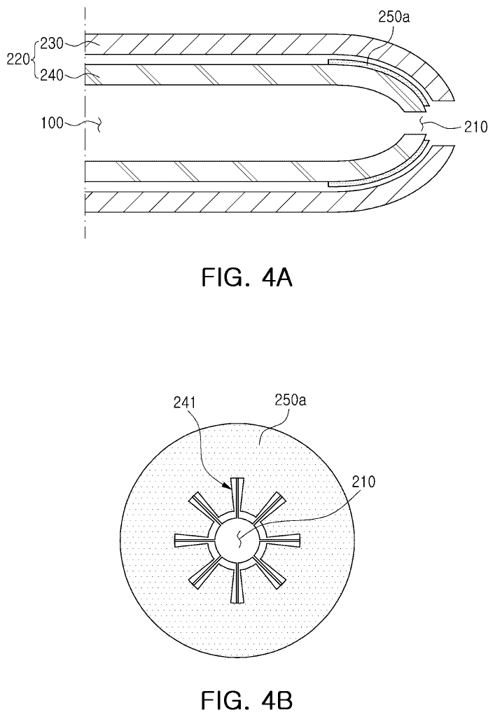

Second to sixth examples of the present disclosure will be described with reference to FIGS. 4A to 16B.

The ejector 10 including the nozzle 200 according to the second to sixth examples of the present disclosure may utilize the first intake portion 100, the first connecting portion 230, the second connecting portion 240 including the cut portion 241, and the spray hole 210 as shown in FIGS. 1 to 3B. Therefore, when describing the second to sixth examples of the present disclosure with reference to FIGS. 4A to 16B, reference will be made to FIGS. 1 to 3B, as well, and any redundant description will be omitted hereinafter.

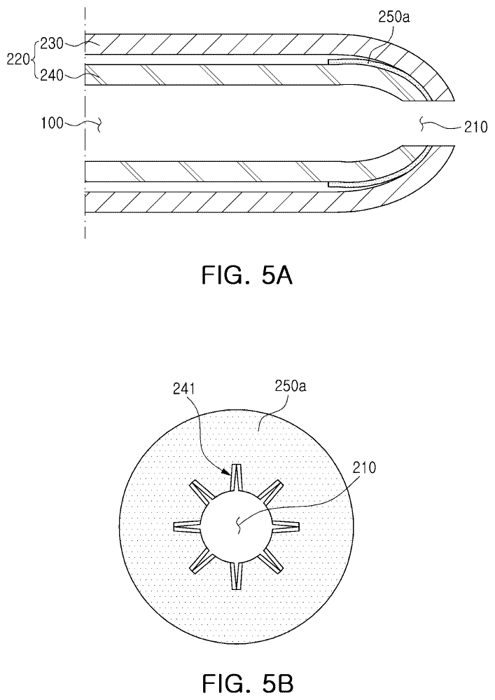

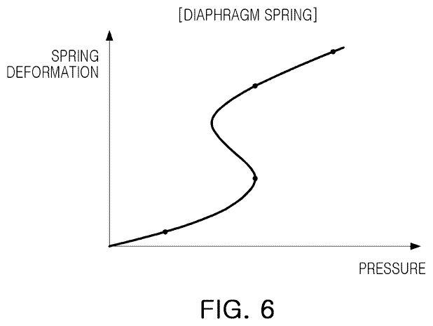

FIG. 4A is a side cross-sectional view of the ejector 10 including the nozzle 200 in a low flow rate state according to a second example of the present disclosure, FIG. 4B is a front view of the second connecting portion 240 and an elastic portion in a low flow rate state according to the second example of the present disclosure, FIG. 5A is a side cross-sectional view of the ejector 10 including the nozzle 200 in a high flow rate state according to the second example of the present disclosure, FIG. 5B is a front view of the second connecting portion 240 and an elastic portion in a high flow rate state according to the second example of the present disclosure, and FIG. 6 is a graph illustrating a spring deformation when an elastic portion is a diaphragm spring according to an example of the present disclosure.

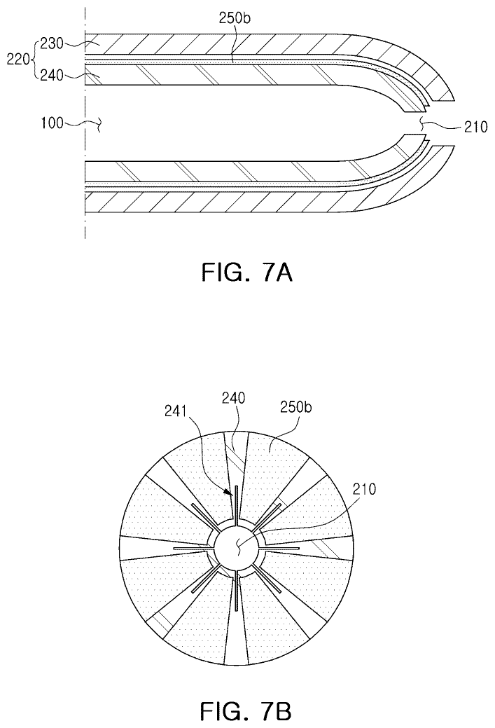

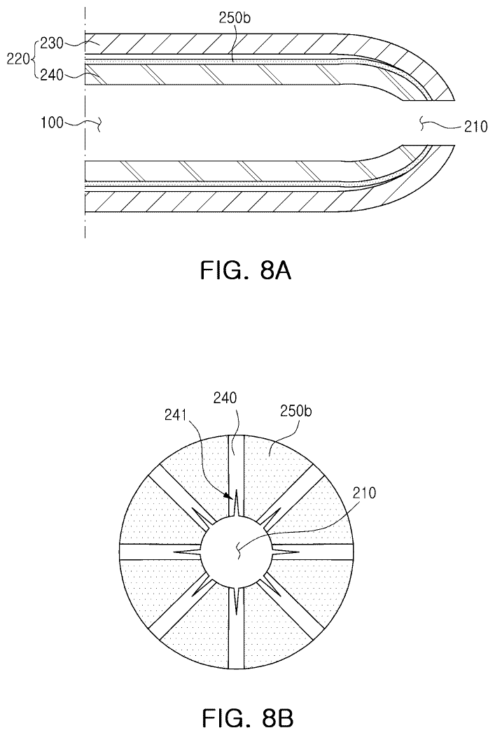

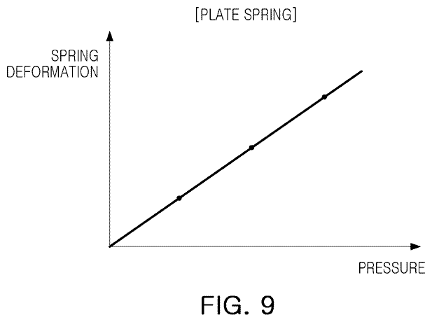

FIG. 7A is a side cross-sectional view of the ejector 10 including the nozzle 200 in a low flow rate state according to a third example of the present disclosure, FIG. 7B is a front view of the second connecting portion 240 and an elastic portion in a low flow rate state according to the third example of the present disclosure, FIG. 8A is a side cross-sectional view of the ejector 10 including the nozzle 200 in a high flow rate state according to the third example of the present disclosure, FIG. 8B is a front view of the second connecting portion 240 and an elastic portion in a high flow rate state according to the third example of the present disclosure, and FIG. 9 is a graph illustrating a spring deformation when the elastic portion is a plate spring 250b according to an example of the present disclosure.

Referring to FIGS. 4A to 5B and FIGS. 7A to 8B, the ejector 10 including the nozzle 200 according to the second and third examples of the present disclosure may further include an elastic portion (e.g., an elastic insert, such as a spring, such as a diaphragm spring 250a and/or plate spring 250b).

The elastic portion may control, via elastic properties/force, the degree of opening of the cut portion 241.

The elastic portion may (e.g., stably) generate an elastic force on/apply an elastic force to the second connecting portion 240. For example, the elastic portion may generate/apply the elastic force, which may adjust a difference in elastic force according to/based on the temperature manufactured as an elastic member/material, to the second connecting portion 240, and may adjust the deformation of the second connecting portion 240.

The elastic portion may reduce the fatigue of a material of the second connecting portion 240 caused by repeatedly performing contraction and/or expansion of the second connecting portion 240. The elastic portion may adjust the deformation of the second connecting portion 240 and/or support/assist in recovery from deformation of the second connecting portion 240.

Referring to FIGS. 4A to 5B, in the ejector 10 including the nozzle 200 according to the second example, the elastic portion may be a diaphragm spring 250a.

Here, the diaphragm spring 250a may be a device having a slit configured to open radially in a cylindrical body.

The slit(s) of the diaphragm spring 250a may correspond to the cut portion 241 disposed along the circumference of a discharge hole/spray hole 210, the degree of opening of the second connecting portion 240 by the cut portion 241 may be adjusted.

Referring to FIGS. 7A to 8B, the ejector 10 including the nozzle 200 according to the third example may have an elastic portion as a plate spring 250b.

Here, the plate spring 250b may be provided in the second connecting portion 240 in the longitudinal direction of the second connecting portion 240, and the degree of opening of the second connecting portion 240 may be adjusted.

Referring to FIG. 6 the diaphragm spring 250a may exhibit deformation with pressure that changes non-linearly, e.g., to include a section in which the deformation of the spring changes rapidly under specific conditions. Referring to FIG. 9, the plate spring 250b may exhibit linear deformation with pressure Therefore, in the ejector 10 including the nozzle 200 of the present disclosure, the plate spring 250a or the diaphragm spring 250b may be applied as an elastic portion according to the properties of the system based on the properties, temperature, and pressure of the fluid.

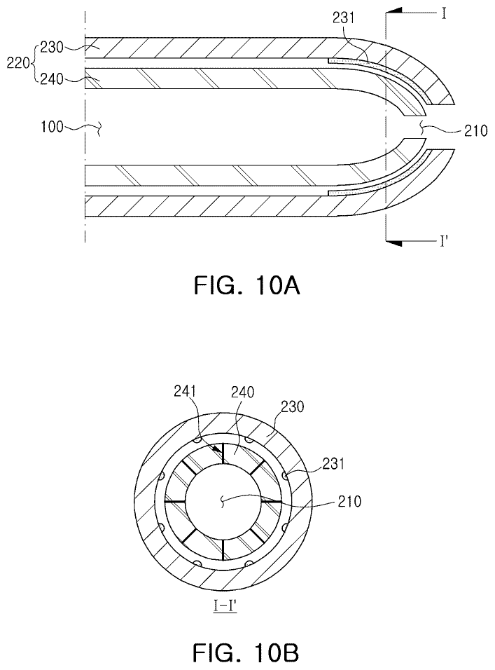

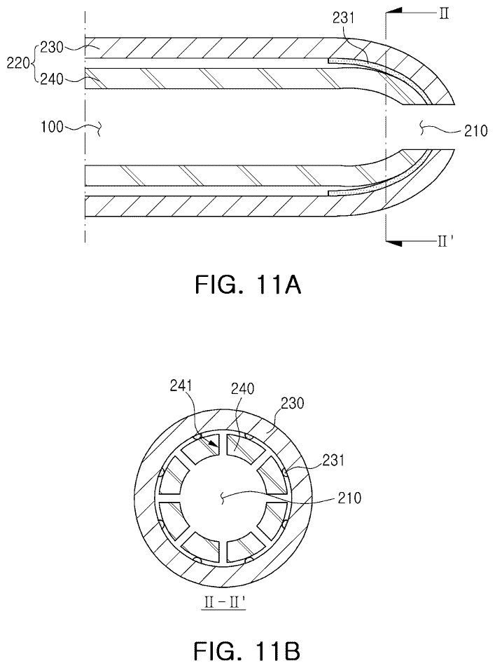

FIG. 10A is a side cross-sectional view of the ejector 10 including the nozzle 200 in a low flow rate state according to a fourth example of the present disclosure, FIG. 10B is a cross-sectional view taken along line I-I′ of FIG. 10A, FIG. 11A is a side cross-sectional view of the ejector 10 including the nozzle 200 in a high flow rate state according to the fourth example of the present disclosure, FIG. 11B is a cross-sectional view taken along line II-II′ of FIG. 11A.

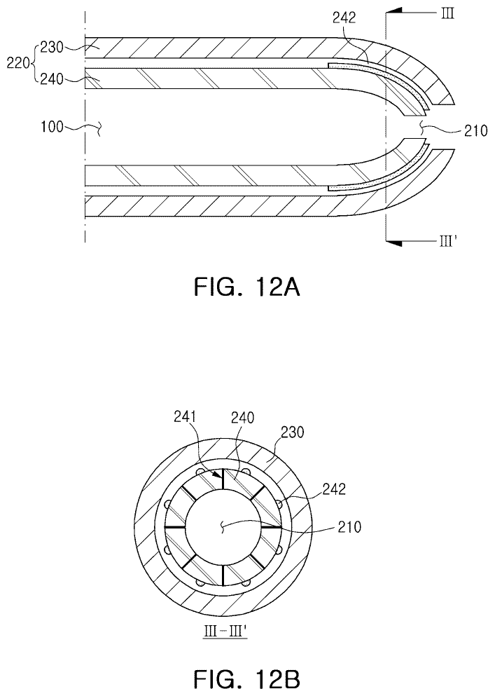

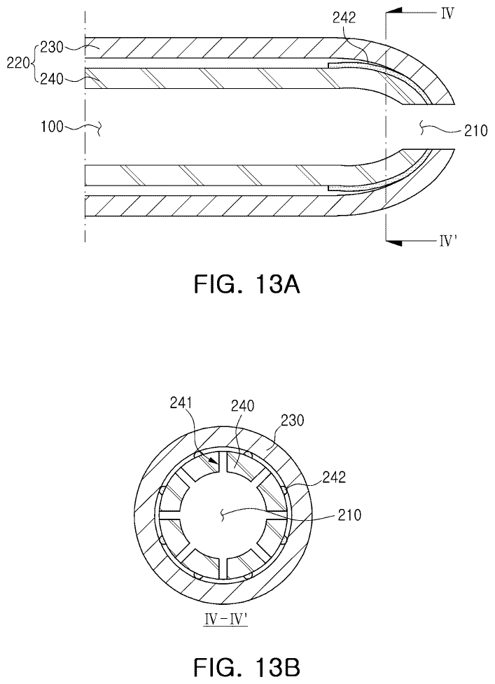

Also, FIG. 12A is a side cross-sectional view of the ejector 10 including the nozzle 200 in a low flow rate state according to a fifth example of the present disclosure, FIG. 12B is a cross-sectional view taken along line III-III′ of FIG. 12A, FIG. 13A is a side cross-sectional view of the ejector 10 including the nozzle 200 in a high flow rate state according to the fifth example of the present disclosure, and FIG. 13B is a cross-sectional view taken along line IV-IV′ of FIG. 13A.

Referring to FIGS. 10A to 11B, the ejector 10 including the nozzle 200 according to the fourth example of the present disclosure may include at least one first protrusion 231 protruding inwardly (e.g., towards the second connecting portion 240) from the first connecting portion 230.

The first protrusion 231 may have a predetermined height inside (e.g., protrusion height from an inside surface of) the first connecting portion 230 and may extend in the longitudinal direction of the first connecting portion 230 (e.g., substantially parallel to a flow direction through the connecting portion 220.

The first protrusion 231 may be disposed between the cut portions 241, which may be cut in the longitudinal direction of the second connecting portion 240.

Referring to FIGS. 10B and 11B, in a case in which the ejector 10 including the nozzle 200 according to the fourth example of the present disclosure includes the first protrusion 231, when a high flow rate flows into the second connecting portion 240, the degree of opening of the cut portion 241 may be limited.

For example, as illustrated in FIG. 11B, as the second connecting portion 240 is (e.g., gradually) opened (e.g., with increased flow rate), an outer surface of the second connecting portion 240 may come into contact with the first protrusion 231, which may thereby limit the opening.

The first protrusion 231 may reduce an elastic deformation region of the second connecting portion 240 by limiting the opening of the second connecting portion 240, thereby improving elastic durability performance of the second connecting portion 240.

Referring to FIGS. 12A to 13B, the ejector 10 including the nozzle 200 according to the fifth example of the present disclosure may include at least one second protrusion 242 protruding (e.g., with a predetermined height) on the outside of the second connecting portion 240 (e.g., from a surface of the second connecting portion 240 towards the first connecting portion 230).

The second protrusion 242 may extend in/along the longitudinal direction of the second connecting portion 240.

The second protrusion 242 may be provided between the cut portions 241 cut in the longitudinal direction of the second connecting portion 240.

Referring to FIGS. 12B and 13B, the ejector 10 including the nozzle 200 according to the fifth example of the present disclosure may limit the degree of opening of the cut portion 241 (e.g., due to a high flow rate through the second connecting portion 240) due to the second protrusion 242.

The second connecting portion 240 including the second protrusion 242 may be easy to manufacture to align between the cut portions 241.

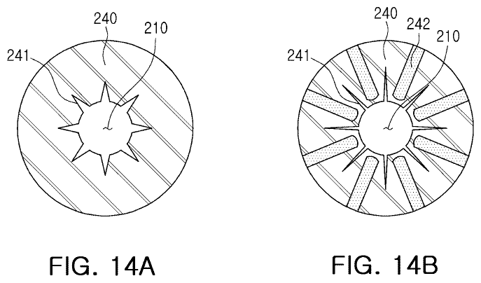

FIGS. 14A and 14B are views illustrating the second connecting portion 240 according to the first example and the connecting portion 220 of the nozzle 200 according to the fifth example in a high flow rate state.

Referring to FIGS. 14A and 14B, when the area of a discharge hole of the second connecting portion 240 according to the first example and the area of a discharge hole according to the fifth example are the same, the cut portion 241 of the fifth example may be formed to be longer in order to form the same area of the discharge holes.

Therefore, in a case in which the area of the discharge hole of the second connecting portion 240 according to the first example and the area of the discharge hole according to the fifth example are the same and the first fluid at high flow rate flows, the opening length of the cut portion 241 of the second connecting portion 240 according to the fifth example may be formed to be longer.

Here, in the ejector 10 including the nozzle 200 according to the fifth example, the contact area of the first fluid passing through the discharge hole with the second fluid may increase and the second fluid transfer performance may be improved.

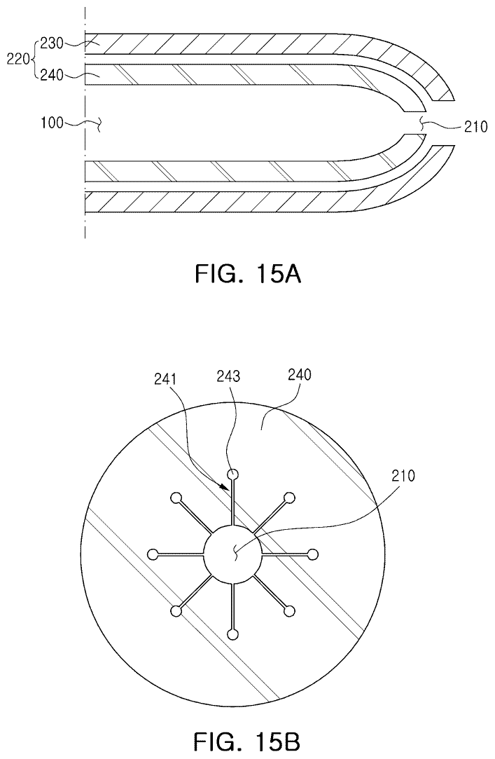

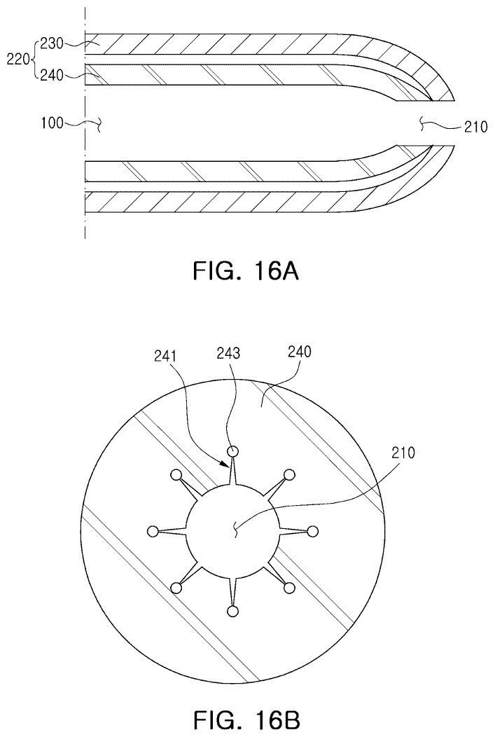

FIG. 15A is a side cross-sectional view of the ejector 10 including the nozzle 200 in a low flow rate state according to a sixth example of the present disclosure, FIG. 15B is a front view of the second connecting portion 240 in a low flow rate state according to the sixth example of the present disclosure, FIG. 16A is a side cross-sectional view of the ejector 10 including the nozzle 200 in a high flow rate state according to the sixth example of the present disclosure, and FIG. 16B is a front view of the second connecting portion 240 in a high flow rate state according to the sixth example of the present disclosure.

Referring to FIGS. 15A and 15B, the ejector 10 including the nozzle 200 according to the sixth example of the present disclosure may further include a reinforcing portion 243.

The reinforcing portion 243 according to the sixth example of the present disclosure may be configured to relieve stress concentration that may occurs when the cut portion 241 is opened.

For example, the reinforcing portion 243 may be/comprise a circular opening formed at the end of the cut portion 241.

The reinforcing portion 243 (e.g., included as a circular opening) may prevent/relieve stress concentration in the second connecting member 240. Preventing/relieving stress may in term prevent/relieve damage to the cut portion 241 (e.g., due to repeated deformation), thereby improving the overall durability performance.

The nozzle 200 and the ejector 10 including the nozzle 200 according to one or more examples of the present disclosure may maximize the fluid transfer performance in various flow rate ranges by changing the discharge outer diameter of the nozzle. Various features of the examples disclosed herein (e.g., any of the first through sixth examples) may be combined and/or applied in a single nozzle 200 and/or ejector including the nozzle 200, according to the present disclosure.

An aspect of the present disclosure is to provide an ejector capable of maximizing fluid transport performance in various flow rate ranges.

According to an aspect of the present disclosure, a nozzle includes: an intake portion into which a fluid is introduced; and a connecting portion having one side connected to the intake portion and the other side having a spray hole, wherein the spray hole has an area changing, depending on the introduced fluid.

The spray hole may be provided to have a smaller area than the intake portion.

The connecting portion may include a first connecting portion and a second connecting portion provided inside the first connecting portion.

The second connecting portion may be provided as a member having elasticity.

The second connecting portion may include a cut portion cut from the spray hole toward the intake portion.

The cut portion may be formed in plural along a circumference of the spray hole.

The nozzle may further include an elastic member provided between the first connecting portion and the second connecting portion.

The elastic member may include at least one of a diaphragm spring or a plate spring.

The first connecting portion may further include a first protrusion protruding toward the second connecting portion inside thereof.

The second connecting portion may include a plurality of cut portions cut from the spray hole toward the intake portion, and the first protrusion may be disposed between the cut portions.

The second connecting portion may further include a second protrusion protruding toward the first connecting portion outside thereof.

The second connecting portion may include a plurality of cut portions cut from the spray hole toward the intake portion, and the second protrusion is disposed between the cut portions.

The cut portion may further include a reinforcing portion provided as a circular hole on the other side of the spray hole.

According to another aspect of the present disclosure, an ejector includes: a chamber portion; the nozzle described above to provide a first fluid to the chamber portion; a second intake portion providing a second fluid to the chamber portion; and a discharge portion connected to the chamber portion and transferring the first fluid and the second fluid introduced into the chamber portion.

The nozzle and the ejector including the nozzle according to an example of the present disclosure may maximize the surface area in which the first fluid and the second fluid come into contact with each other by changing the nozzle shape.

The nozzle and the ejector including the nozzle according to an example of the present disclosure may have excellent durability performance because they include a stress concentration preventing structure.

While examples have been shown and described above, it will be apparent to those skilled in the art that modifications and variations could be made without departing from the scope of the present disclosure as defined by the appended claims.

What is claimed is:

1. A nozzle comprising:
an intake portion forming an opening configured to introduce a fluid to the nozzle; and
a nozzle body having a first end connected to the intake portion and a second end, opposite to the first end, forming a spray hole,
wherein an area of the spray hole is configured to change based on a flow rate of the introduced fluid.

2. The nozzle of claim 1, wherein the area of the spray hole is smaller than an area of the opening formed by the intake portion.

3. The nozzle of claim 1, wherein the nozzle body comprises:
a first connecting portion; and
a second connecting portion provided inside the first connecting portion.

4. The nozzle of claim 3, wherein the second connecting portion is elastically deformable.

5. The nozzle of claim 3, wherein the second connecting portion forms one or more cuts that each extend from the spray hole toward the intake portion.

6. The nozzle of claim 5, wherein the one or more cuts are a plurality of cuts spaced along a circumference of the spray hole.

7. The nozzle of claim 3, further comprising an elastic insert provided between the first connecting portion and the second connecting portion.

8. The nozzle of claim 7, wherein the elastic insert comprises at least one of:
a diaphragm spring, or
a plate spring.

9. The nozzle of claim 3, wherein the first connecting portion comprises a first protrusion protruding toward the second connecting portion.

10. The nozzle of claim 9, wherein the second connecting portion forms a plurality of cuts extending from the spray hole toward the intake portion, and
wherein the first protrusion is disposed between two adjacent cuts of the plurality of cuts.

11. The nozzle of claim 3, wherein the second connecting portion comprises a second protrusion protruding toward the first connecting portion.

12. The nozzle of claim 11, wherein the second connecting portion forms a plurality of cuts extending from the spray hole toward the intake portion, and
wherein the second protrusion is disposed between two adjacent cuts of the plurality of cuts.

13. The nozzle of claim 5, wherein each of the one or more cuts extend from the spray hole to an end having a shape of a circular hole.

14. An ejector comprising:
a chamber;
a nozzle comprising:
a first intake portion forming an opening configured to introduce a first fluid to the nozzle; and
a nozzle body having a first end connected to the first intake portion and a second end, opposite to the first end, forming a spray hole configured to provide the first fluid to the chamber,
wherein an area of the spray hole is configured to change based on a flow of the first fluid;
a second intake portion forming an opening configured to provide a second fluid to the chamber; and
a discharge nozzle, connected to the chamber, configured to discharge the first fluid and the second fluid from the chamber.

15. The ejector of claim 14, wherein the nozzle body comprises:
a first connecting portion; and
a second connecting portion provided inside the first connecting portion.

16. The ejector of claim 15, wherein the second connecting portion is elastically deformable.

17. The ejector of claim 15, wherein the second connecting portion forms one or more cuts that each extend from the spray hole toward the first intake portion.

18. The ejector of claim 14, wherein a shape of the spray hole comprises a plurality of cuts outward from a center of the spray hole.

19. A nozzle comprising:
a nozzle body having a first end configured to receive a fluid and a second end, opposite to the first end, forming a spray hole;
wherein the nozzle body comprises:
a first nozzle body wall; and
a second nozzle body wall provided inside the first nozzle body wall; and
wherein the second nozzle body wall comprises an elastic material configured to cause an area of the spray hole to change based on a flow rate of the received fluid.
